(19) United States
(12) Patent Application Publication
(10) Pub. No.: US 2017/0348193 A1
(43) Pub. Date: Dec. 7, 2017

(54) PILL CRUSHING SYSTEM

(71) Applicants: Peter Bonaminio, Orland Park, IL (US); Nancy Bonaminio, Orland Park, IL (US)

(72) Inventors: Peter Bonaminio, Orland Park, IL (US); Nancy Bonaminio, Orland Park, IL (US)

(21) Appl. No.: 15/171,538

(22) Filed: Jun. 2, 2016

(51) Int. Cl. A61J 7/00; A61J 3/02

(52) U.S. Cl. CPC A61J 7/0007; A61J 7/0053; A61J 3/02; A61J 7/0046

(57) ABSTRACT

The presently described technology provides a pill crushing system. The pill crushing system may comprise a tablet crusher, a bowl-like structure, and an elongated cylindrical weighted rod. The tablet crusher may have an open mouth, a lower end of the tablet crusher and a cap. The lower end of the tablet crusher may have a closed base provided with a peripheral thread along surface wall of the closed base. The cap may have a peripheral thread for engagement with the peripheral thread of the tablet crusher. The threaded arrangement for the tablet crusher and the cap are such as to bring the cap close to the closed base of the tablet crusher into engagement with the cap upon turning the cap in one direction, whereby a pill interposed therebetween may be crushed. The bowl-like structure may have smooth surfaces such that a residue after a pill is grounded in the bowl-like structure is less than 2 wt % of the pill. The elongated cylindrical weighted rod may have smooth surfaces at one end.

### BACKGROUND OF THE INVENTION

The present invention disclosure relates to devices for crushing or pulverizing tablets or pills into a powder form, and more particularly to a kit for quickly and easily crushing and pulverizing individual or small numbers of tablets or pills at a time.

Generally speaking, the most effective and the least expensive means and method for manufacturing and dosing medications is in a solid pill form. The term “pill” commonly refers to pharmacological oral doses of active ingredient(s) in solid form. Unfortunately, there are several potential problems associated with the administration of this particular medium of medication. Problems include patients with strong gag reflexes or impaired swallowing ability due to various medical conditions, swallowing disorders associated with aging, impaired mental status, altered levels of consciousness, fear of choking mediated reactions, and a general difficulty in swallowing pills as a whole. As a more specific example, any pills must be crushed if the individual must use a so-called PED, or percutaneous endoscopic gastrostomy tube. In addition, many healthy people have trouble swallowing pills such as vitamins, particularly multivitamins and the like frequently having a relatively large diameter. In fact, the ability to swallow large solid masses of anything is principally a learned reaction which does not conform well to an untrained body's natural reflexes.

Traditionally, nurses, pharmacists, and other medication dispensing personnel frequently resort to the use of hammers or mallets used in combination with bowl-like containers. Typically, the striking head of a hammer is positioned at a right angle with respect to the handle, and it is brought downwardly following a generally arcuate path into contact with the top surface of the item to be broken into pieces or crushed.

There are several disadvantages to hammer techniques of crushing pills. One disadvantage is that techniques require a significant amount of manual force from the user to achieve the desired pill crushing effect. In particular, the conventional hammer is designed to provide a maximum amount of striking force, much more than is required to split and then crush a typical pill or tablet to be ingested. In addition, unless the user has practiced using a hammer or mallet, or has unusually good hand eye coordination, he or she will likely have surprisingly poor aim and control of the hammer, particularly where attempting to hit a small pill or tablet.

There is therefore a need for a tablet or pill crushing or pulverizing system and apparatus that is inexpensive and easy to use, and wherein the user can see the pill or tablet as it is being crushed.

### BRIEF SUMMARY

In one embodiment, a pill crushing system may comprise a tablet crusher, a bowl-like structure, and an elongated cylindrical weighted rod. The tablet crusher may have an open mouth, a lower end of the tablet crusher and a cap. The lower end of the tablet crusher may have a closed base provided with a peripheral thread along surface wall of the closed base. The cap may have a peripheral thread for engagement with the peripheral thread of the tablet crusher. The threaded arrangement for the lower end of the tablet crusher and the cap are such as to bring the cap close to the closed base of the tablet crusher into engagement with the cap upon turning the cap in one direction. A pill interposed therebetween may be crushed. The bowl-like structure may have smooth surfaces such that a residue after the pill is grounded in the bowl-like structure is less than 2 wt % of the pill. The elongated cylindrical weighted rod may have smooth surfaces at one end.

In another embodiment, the present technology relates to a method of crushing a pill into powder. The method may be carried out by a multiple steps. The prescription or label of a pill should be checked to see if the pill can be crushed. If the pill can be crushed, the pill may be put into a tablet crusher that has a screwed cap. The screwed cap may be turned to crush the pill into pieces. The pieces may be transferred to a bowl-like container. An elongated cylindrical weighted rod that has smooth surfaces at one end may be used to crush the pieces into powder.

In another aspect, a pill crushing system may comprise a tablet crusher, a bowl-like structure, at least one bottle of syrup, and a plurality of dosing devices. The tablet crusher may have an open mouth, a lower end and a cap. The lower end of the tablet crusher may have a closed base provided with a peripheral thread along surface wall of the closed base. The cap may have a peripheral thread for engagement with the peripheral thread of the tablet crusher. The threaded arrangement for the tablet crusher and the cap are such as to bring the cap close to the closed base of the tablet crusher into engagement with the cap upon turning the cap in one direction, whereby a pill interposed therebetween may be crushed. The bowl-like structure may have smooth surfaces such that a residue after a pill is grounded in the bowl-like structure is less than 2 wt % of the pill. The syrup may have various flavors, such as bubble gum, grape, chicken, beef, tuna or berry.

### BRIEF DESCRIPTION OF SEVERAL VIEWS OF THE DRAWINGS

FIG. 1 is a prospective view of a pill crushing system in one exemplary embodiment.

FIG. 2 is a close-up view of a tablet crusher having a peripheral thread at the lower end according to one exemplary embodiment.

FIG. 3 is a flow chart illustrating a method of crushing a pill into powder.

### DETAILED DESCRIPTION OF THE INVENTION

The present disclosure can be understood more readily by reference to the following detailed description, drawings, examples, and claims, and their previous and following description. However, before the present articles, devices, and methods are disclosed and described, it is to be understood that this disclosure is not limited to the specific articles, devices, and methods disclosed unless otherwise specified, as such can, of course, vary. It is also to be understood that the terminology used herein is for the purpose of describing particular aspects only and is not intended to be limiting.

The following description of the disclosure is provided as an enabling teaching of the disclosure in its currently known embodiments. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Reference will now be made in detail to the present preferred embodiment(s), examples of which are illustrated in the accompanying drawings. The use of a particular reference character in the respective views indicates the same or like parts.

Broadly, the present disclosure relates to a crushing system, more specifically, a pill crushing system. The pill crushing system may also be used a kit. The kit may be portable and light weighted.

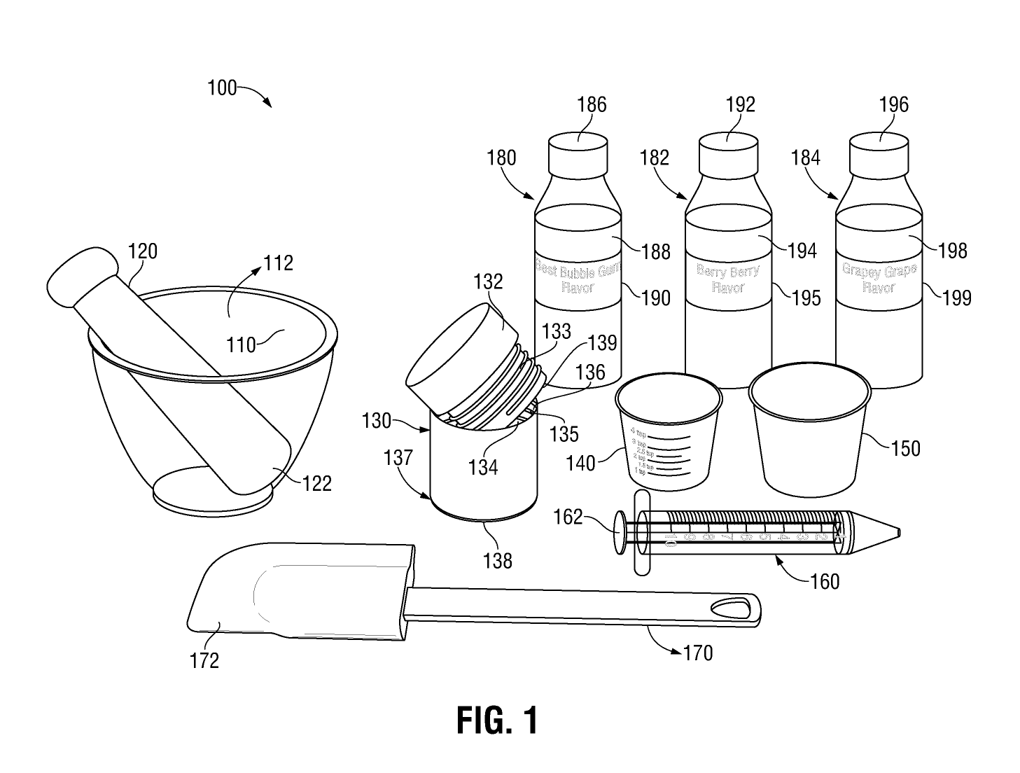

As shown in FIG. 1, a pill crushing system 100 may comprise a tablet crusher 130, a bowl-like structure 110, and an elongated cylindrical weighted rod 120. The tablet crusher 130 may have an open mouth 136, a lower end 137 of the tablet crusher and a cap 132. The lower end 137 of the tablet crusher 130 may have a closed base 138 provided with a peripheral thread 135 along surface wall 134 of the closed base 138. The cap 132 may have a peripheral thread 133 for engagement with the peripheral thread 135 of the tablet crusher 130. The threaded arrangement for the lower end 137 of the tablet crusher 130 and the cap 132 are such as to bring the cap 132 close to the closed base 138 of the tablet crusher 130 into engagement with the cap 132 upon turning the cap 132 in one direction. A pill interposed therebetween may be crushed. The bottom surface 139 of the cap 132 may be flat in one embodiment. In another embodiment, the bottom surface 139 may be rough. The bottom surface 139 may be coated by a plurality of particles, such as SiO₂, or a polymer film, etc.

The bowl-like structure 110 may have smooth surfaces 112 such that a residue after the pill is grounded in the bowl-like structure 110 is less than 2 wt % of the pill. The bowl-like structure may be made of a material having small pores so that the small pores on the smooth surfaces 112 may contain less than 2 wt % of the pill after grinding, for example. The bowl-like structure may be made of glass and may be about 2-oz size.

The elongated cylindrical weighted rod 120 may have smooth surfaces at one end 122. Alternatively, the elongated cylindrical weighted rod 120 may have rough surfaces at the one end 122. The rough surfaces may be made possible by coating a plurality of particles, such as SiO₂, or a polymer film, etc. As used throughout this specification and the appended claims, the term “weighted rod” or “rod” broadly refers to rods having a particular weight or meeting a certain threshold weight requirement suitable for use in accordance with the present embodiment. Weighted rods can be constructed of some solid material whereby the density of the material is uniform throughout the rod. Alternatively, weighted rods can be constructed in such a manner that the ends of the rods are made heavier than the body of the rod. The weighted rods having heavier ends are not limited to any particular internal structure, and can be, but are not limited to having, a solid, hollow, or partially hollowed configuration.

The pill crushing system 100 may further include instructions for use of the pill crushing system in a method of converting the pill into powder for a human, such as a pediatric patient, an elderly patient, a normative patient, or an animal patient. The instructions may include a pamphlet, a video such as DVD, with an emphasis on fresh preparation.

The pill crushing system 100 may further include a spatula 170. The spatula 170 may have a rubber protective end 172. The pill crushing system 100 may further include a plurality of dosing devices, such as a graduated dose syringe 160, 4-tea spoon measuring cup 140, or 5 or 6-tea spoon measuring cup 150. The graduated dose syringe 160 may further include a plunger 162. The pill crushing system 100 may further include at least one syrup bottle 180, 182, or 184. The syrup may have various flavors, such as bubble gum, grape, chicken, beef, tuna or berry flavors. The bottle 180 may have a cap 186, a body 188, and a label 190. The bottle 180 may contain syrup with a bubble gum flavor. The bottle 182 may have a cap 192, a body 194, and a label 195. The bottle 182 may contain syrup with a berry flavor. The bottle 184 may have a cap 196, a body 198, and a label 199. The bottle 184 may contain syrup with a grape flavor.

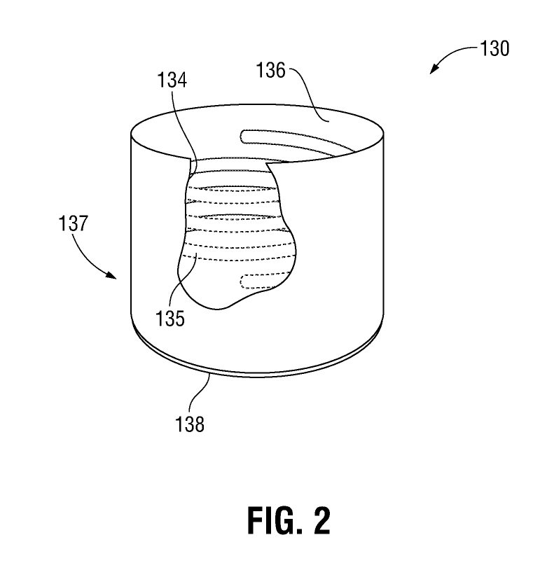

FIG. 2 shows a closed-up view of the tablet crusher 130. The lower end 137 of the tablet crusher 130 may have a several rounds of the peripheral thread 135 along surface wall 134. The peripheral thread 135 may match the thread 133 of the cap 132 (shown in FIG. 1).

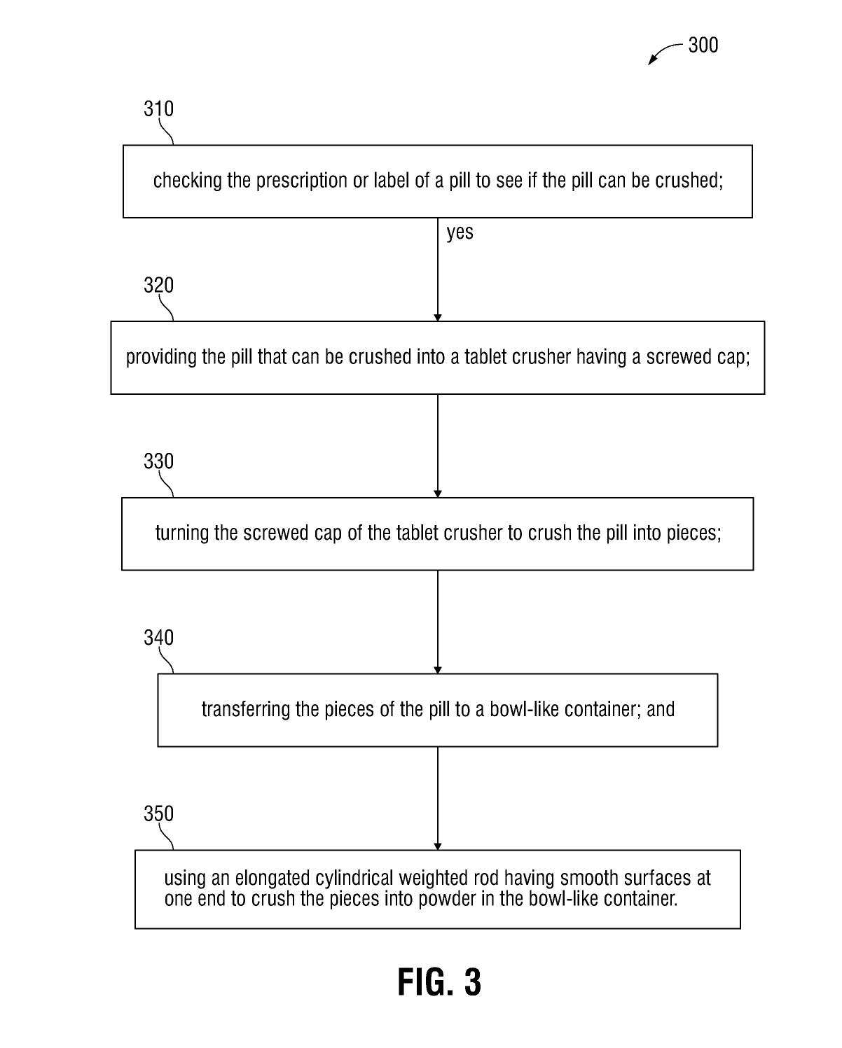

FIG. 3 illustrates a flow chart of a method 300 of crushing a pill into powder. The method 300 may be carried out by a multiple steps. The prescription or label of a pill should be checked to see if the pill can be crushed in a step 310. If the pill can be crushed, the pill may be provided into a tablet crusher that has a screwed cap in a step 320. The screwed cap may be turned to crush the pill into pieces in a step 330. The pieces may be transferred to a bowl-like container in a step 340. An elongated cylindrical weighted rod that has smooth surfaces at one end may be used to crush the pieces into powder in the bowl-like container in a step 350.

Some medications are not intended to be crushed-up. Medications that are ‘extended-release”, “enteric-coated” “delayed-release” are designed not to be crushed. A list of pills that cannot be crushed may include acamprosate, acetaminophen, acetazolamide, albuterol, alendronate, alfuzosin, alprazolam, ambrisentan, amoxicillin, aspirin, atomoxetine, belladonna alkaloids, benzonatate, bisacodyl, bosentan, bosutinib, budesonide, bupropion, cabozantinib, carbamazepine, carbvedilol, cefuroxime, chlorpheniramine maleate, ciprofloxacin, clarithromycin, clonidine, colestipol, cyclobenzaprine, cyclophosphamide, dabigatran, dalfampridine, darifenacin, dasatinib, deferasirox, desvenlafaxine, dexlansoproazole, dextroamphetamine, dexmethylphenidate, diclofenac, didanosine, diflunisal, diltiazem, dimethyl furmarate, disopyramide, divalproex, docusate sodium, donepezil, doxazosin, doxycycline, duloxetine, dutasteride, enzalutamide, ergotamine, erythromycin, esomeprazole, eszopiclone, etravirine, everolimus, felodipine, fentanyl, ferrous gluconate, ferrous sulfate, fesoterodine, finasteride, fluoxetine, fluvastatin, fluvoxamine, gabapentin, galantamine, ganciclovir, glipizide, guaifenesin, guanfacine, hydromorphone, hydroxyurea, hyoscyamine, ibandronate, ibuprofen, imatinib, indinavir, indomethacin, isosorbide dinitrate, isosorbide mononitrate, isotretinoin, isradipine, lamotrigine, lansoprazole, leflunomide, lenalidomide, levetiracetam, levodopa, lithium carbonate, lopinavir/ritonavir, loratadine/pseudoephedrine, lovastatin, lubiprostone, macitentan, memantine, mesalamine, mesalamine, metformin, mythylphenidate, metoprolol succinate, metoprolol tartrate, metronidazole, minocycline, miragegron, morphine sulfate, morphine/naltrexone, mycophenolate, mycophenolic acid, naproxen, nevirapine, niacin, nicardipine, nicotine, nifedipine, nilotinib, nisoldipine, nitroglycerin, omeprazole, orphenadrine, oxybutynin, oxycodone, oxymorphone, paliperidone, pancreatic enzymes, pantoprazole, paroxetine, pentoxifylline, phenylephrine/brompheniramine, piroxicam, pomalidomide, potassium chloride, praziquantel, promethazine, propafenone, propranolol, pseudoephedrine, pyridostigmine, quetiapine, rabeprazole, raloxifene, ranolazine, regorafenib, ribavirin, risedronate, risperiodone, ropinirole, simeprevir, solifenacin, sulfasalazine, sunitinib, tamsulosin, tapentadol, telithromycin, temozolomide, thalidomide, theophylline, tipranavir, tolterodine, topiramate, tramadol, trazodone, trospium, valganciclovir, valproic acid, vandetanib, venlafaxine, verapamil, vismodegib, vorinostat, zileuton, zolpidem, etc. Care should be taken not to crush a medication that is not designed to be crushed. Some medications can cause a burning or numbing sensation if their coating is removed.

If the pill is checked that can be crushed, the pill may be put into a tablet crusher 130 as shown in FIGS. 1 and 2. The screwed cap may then be turned along the peripheral thread to crush the pill into pieces. The pieces of the pill may then be transferred to a bowl-like container, which is about 2 oz size. The bowl-like structure may have smooth surfaces such that a residue after a pill is grounded in the bowl-like structure is less than 2 wt % of the pill. An elongated cylindrical weighted rod having smooth surfaces at one end may be used to crush the pieces into powder. Firm pressure may be applied to the pill and hammering should be avoided. Care should be taken so that there are no crumbs exit the bowl-like structure. Any crumbs leave the bowl-like structure will reduce the amount of medication that the patient receives. After the pill is reduced to fine crumbs, the elongated cylindrical weighted rod should be pressed down with a circular mixing motion to reduce the pill to a fine powder.

A graduated dose syringe may be used to get syrup from a bottle and release the syrup to the bowl-like container or the tablet crusher if there is some residue left. Alternatively, flavored syrup may be poured into the bowl-like structure to mix the powder. In further embodiment, flavored syrup, such as 10 ml, may be added into the measuring cup. A small portion of the flavored syrup may be added to the mortar. The syrup may be added and used to wash the rod to make sure there is no residue left or 10 ml of the syrup is used. It is not recommended to pour the entire 10 ml of syrup in at once to attempt to get a quick mix. Experience has shown that it may not produce a good product.

The powder may not dissolve into the syrup and may form a suspension. Water (drinking water or distilled water), such as 10 ml, may be added to the measuring cup. A small amount of water may be added to the bowl-like structure to mix with the suspension until all of 10 ml are used or a desired consistency is reached. The suspension may be transferred to a measuring cup for a patient to use. Or a patient may drink the entire dose right out of the bowl-like structure with a straw. Or a graduated dose syringe may be used to feed an animal. A spatula may be used to scrap a leftover in the bowl-like structure to the measuring cup. A few drops of clean drinking water may be used to wash the bowl-like container to make sure most residues are picked up. Any medication left behind may result in a smaller dose the patient will receive.

In another embodiment, a pill may be crushed by a tablet crusher into powder. The powder may be transferred to apple sauce or yogurt and may be mixed well for a patient to use.

### Example I

A nine-year old girl who does not like taking pills was tested to use the kit with the help of her mother. The first time they used was a little slow. At the second time, they used much faster. The grape flavored syrup was used and preferred. Very little water was added. The girl drank her medication from a small cup both times. Overall, the kit was very easy and simple to use.

### Example II

A seventy-one year old who has difficulty swallowing large pills was tested to use the kit. The tablets were two large pills and were difficult to crush. The tablets had to be snapped in half. The user used the spatula to get the “paste” medicine with water and syrup mixture off the sides of the rod. The user might have a few “small chucks” of medication in the final mixture. Syrup and water should be used in double size. Overall, the kit was simple to use.

### Example III

A four-year old girl having special needs was tested to use the kit with the help of her father. The four-year old girl liked the process of crushing the pill and mixing with flavored syrup. Overall, the kit was very easy to use.

In the present specification, use of the singular includes the plural except where specifically indicated.

The presently described technology is now described in such full, clear, concise, and exact terms as to enable any person skilled in the art to which it pertains, to practice the same. It is to be understood that the foregoing describes preferred embodiments of the technology and that modifications may be made therein without departing from the spirit or scope of the invention as set forth in the appended claims.

1. A pill crushing system, comprising
a tablet crusher having an open mouth, a lower end of the tablet crusher having a closed base provided with a peripheral thread along surface wall of the closed base, a cap having a peripheral thread for engagement with the peripheral thread of the tablet crusher, the threaded arrangement for the lower end of the tablet crusher and the cap being such as to bring the cap close to the closed base of the tablet crusher into engagement with the cap upon turning the cap in one direction, whereby a pill interposed therebetween may be crushed;
a bowl-like structure having smooth surfaces such that a residue after the pill is grounded in the bowl-like structure is less than 2 wt % of the pill; and
an elongated cylindrical weighted rod having smooth surfaces at one end.

2. The pill crushing system of claim 1, further comprising instructions for use of the pill crushing system in a method of converting the pill into powder for a human or animal patient.

3. The pill crushing system of claim 2, wherein the patient is a pediatric patient.

4. The pill crushing system of claim 2, wherein the patient is an elderly patient.

5. The pill crushing system of claim 2, wherein the patient is a normative patient.

6. The pill crushing system of claim 1, further comprising a spatula having a rubber protective end.

7. The pill crushing system of claim 1, further comprising a plurality of dosing devices.

8. The pill crushing system of claim 7, wherein the plurality of dosing devices includes a graduated dose syringe.

9. The pill crushing system of claim 1, wherein the bowl-like structure is about 2-oz size.

10. The pill crushing system of claim 1, further comprising at least one bottle of syrup, wherein the syrup have various flavors.

11. The pill crushing system of claim 10, wherein the various flavors include at least one of bubble gum, grape, chicken, beef, tuna or berry.

12. The pill crushing system of claim 7, wherein the plurality of dosing devices include a measuring cup.

13. The pill crushing system of claim 1, wherein the bowl-like structure is made of glass.

14. A method of crushing a pill into powder, comprising:
checking the prescription or label of a pill to see if the pill can be crushed;
providing the pill that can be crushed into a tablet crusher having a screwed cap;
turning the screwed cap to crush the pill into pieces;
transferring the pieces of the pill to a bowl-like container; and
using an elongated cylindrical weighted rod having smooth surfaces at one end to crush the pieces into powder.

15. The method of claim 14, wherein the bowl-like container comprises about 2 oz size.

16. The method of claim 13, wherein the bowl-like structure has smooth surfaces such that a residue after a pill is grounded in the bowl-like structure is less than 2 wt % of the pill.

17. A kit, comprising
a tablet crusher having an open mouth, a lower end of the tablet crusher having a closed base provided with a peripheral thread along surface wall of the closed base, a cap having a peripheral thread for engagement with the peripheral thread of the tablet crusher, the threaded arrangement for the tablet crusher and the cap being such as to bring the cap close to the closed base of the tablet crusher into engagement with the cap upon turning the cap in one direction, whereby a pill interposed therebetween may be crushed;
a bowl-like structure having smooth surfaces such that a residue after the pill is grounded in the bowl-like structure is less than 2 wt % of the pill;
at least one bottle of syrup, wherein the syrup has various flavors; and
a plurality of dosing devices.

18. The kit of claim 17, wherein the bowl-like structure is made of glass.

19. The kit of claim 17, further comprising an elongated cylindrical weighted rod having smooth surfaces at one end.

20. The kit of claim 17, wherein the various flavors include at least one of bubble gum, grape, chicken, beef, tuna or berry.
